(19) United States
(12) Patent Application Publication
(10) Pub. No.: US 2025/0132867 A1
(43) Pub. Date: Apr. 24, 2025

(54) METHOD AND APPARATUS FOR SUPPORTING ENHANCED TYPE-3 HYBRID AUTOMATIC REPEAT REQUEST-ACKNOWLEDGEMENT (HARQ-ACK) CODEBOOKS IN MOBILE COMMUNICATIONS

(71) Applicant: MediaTek Singapore Pte. Ltd., Singapore (SG)

(72) Inventors: Mohammed S Aleabe AL-IMARI, Cambridge (GB); Abdellatif SALAH, Cambridge (GB)

(21) Appl. No.: 18/685,609

(22) PCT Filed: Aug. 12, 2022
(86) PCT No.: PCT/CN2022/112133

§ 371 Date: Feb. 22, 2024

Related U.S. Application Data
(60) Provisional application No. 63/236,275, filed on Aug. 24, 2021.

(51) Int. Cl. H04L 1/1822; H04B 7/0456; H04L 1/1812; H04L 1/1829; H04L 5/00

(52) U.S. Cl. CPC H04L 1/1822; H04B 7/0456; H04L 1/1812; H04L 1/1864; H04L 5/0055

(57) ABSTRACT

Various solutions for supporting enhanced type-3 hybrid automatic repeat request-acknowledgement (HARQ-ACK) codebooks with respect to user equipment and network apparatus in mobile communications are described. An apparatus may receive a radio resource control (RRC) configuration from a network node. The RRC configuration includes first information indicating that a support of multiple enhanced type-3 HARQ-ACK codebooks is enabled. The apparatus may receive a downlink control information (DCI) format from the network node. The DCI format indicates one of the multiple enhanced type-3 HARQ-ACK codebooks. The apparatus may report HARQ feedback information to the network node based on the one of the multiple enhanced type-3 HARQ-ACK codebooks.

### CROSS REFERENCE TO RELATED PATENT APPLICATION(S)

The present disclosure claims the priority benefit of U.S. Provisional Patent Application No. 63/236,275, filed on 24 Aug. 2021. The contents of aforementioned application are herein incorporated by reference in their entirety.

### TECHNICAL FIELD

The present disclosure is generally related to mobile communications and, more particularly, to supporting enhanced type-3 hybrid automatic repeat request-acknowledgement (HARQ-ACK) codebooks with respect to user equipment and network apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR), hybrid automatic repeat request (HARQ) feedback mechanism is introduced to improve transmission reliability and robustness. The user equipment (UE) needs to report HARQ feedback information for corresponding downlink receptions in a HARQ-ACK codebook. The HARQ-ACK codebook should be transmitted in a slot indicated by a value of a HARQ feedback timing indicator field in a corresponding downlink control information (DCI) format. The DCI format should also indicate the physical uplink control channel (PUCCH) resource scheduled for transmission of the HARQ-ACK information. HARQ-ACK multiplexing can be used to facilitate HARQ-ACK information transmission. Multiple HARQ-ACK feedbacks corresponding to multiple physical downlink shared channel (PDSCH) transmissions may be accumulated, multiplexed and transmitted to the network apparatus at once. One PUCCH resource may be used to carry multiple HARQ-ACK feedbacks to be transmitted in the same slot.

There are three types of HARQ-ACK codebooks, including type-1 HARQ-ACK codebook, type-2 HARQ-ACK codebook, and type-3 HARQ-ACK codebook, defined in current NR framework. Type-1 HARQ-ACK codebook is a semi-static codebook, and the number of bits to send in an ACK/NACK report is fixed and could be potentially large. Type-2 HARQ-ACK codebook is a dynamic codebook with which the UE sends HARQ feedbacks only for the scheduled carriers. Type-3 HARQ-ACK codebook is introduced in Rel-16 for use of the HARQ-ACK codebook retransmission and is applicable for one-shot feedback. However, the existing Rel-16 type-3 HARQ-ACK codebook may show some limitations to support an ultra-reliable and low latency communications (URLLC) service. URLLC is introduced for emerging applications that demands high requirements on end-to-end latency and reliability. URLLC traffic is typically sporadic and short, and the volume of HARQ feedbacks for URLLC traffic is typically small and also variant. For example, the existing HARQ feedback mechanism using type-3 HARQ-ACK codebook requires the UE to send ACK/NACK report for all the cells of the same cell group even if there is no scheduling received from one of the cells or even one of the cells is not activated (i.e., the HARQ-ACK of the inactive cell is also reported), and this is not very flexible in terms of size reduction.

Accordingly, how to optimize the HARQ feedback mechanism with enhanced type-3 HARQ-ACK codebook becomes an important issue for URLLC or other applications (e.g., for unlicensed frequency bands) in the newly developed wireless communication network. Therefore, there is a need to provide support of enhanced type-3 HARQ-ACK codebooks for better performance with URLLC services or other applications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to supporting enhanced type-3 HARQ-ACK codebooks with respect to user equipment and network apparatus in mobile communications.

In one aspect, a method may involve an apparatus receiving a radio resource control (RRC) configuration from a network node, wherein the RRC configuration comprises first information indicating that an operation of multiple enhanced type-3 HARQ-ACK codebooks is enabled. The method may also involve the apparatus receiving a downlink control information (DCI) format from the network node, wherein the DCI format indicates one of the multiple enhanced type-3 HARQ-ACK codebooks. The method may further involve the apparatus reporting HARQ feedback information to the network node based on the one of the multiple enhanced type-3 HARQ-ACK codebooks.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising receiving, via the transceiver, an RRC configuration from a network node, wherein the RRC configuration comprises first information indicating that an operation of multiple enhanced type-3 HARQ-ACK codebooks is enabled. The processor may also perform operations comprising receiving, via the transceiver, a DCI format from the network node, wherein the DCI format indicates one of the multiple enhanced type-3 HARQ-ACK codebooks. The processor may further perform operations comprising reporting, via the transceiver, HARQ feedback information to the network node based on the one of the multiple enhanced type-3 HARQ-ACK codebooks.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIG. 2 is a block diagram of an example communication apparatus and an example network apparatus in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to supporting enhanced type-3 HARQ-ACK codebooks with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In current NR framework, type-3 HARQ-ACK codebook is introduced in Rel-16 for use of the HARQ-ACK codebook retransmission and is applicable for one-shot feedback. However, the type-3 HARQ-ACK codebook may show some limitations to support a URLLC service. For example, the existing HARQ feedback mechanism using type-3 HARQ-ACK codebook requires the UE to send ACK/NACK report for all the cells of the same cell group even if there is no scheduling received from one of the cells or even one of the cells is not activated (i.e., the HARQ-ACK of the inactive cell is also reported), and this is not very flexible in terms of size reduction. Therefore, there is a need to provide support of enhanced type-3 HARQ-ACK codebooks for better performance with URLLC services or other applications (e.g., for unlicensed frequency bands).

In view of the above, the present disclosure proposes a number of schemes pertaining to supporting enhanced type-3 HARQ-ACK codebooks with respect to user equipment and network apparatus in mobile communications. According to the schemes of the present disclosure, multiple enhanced type-3 HARQ-ACK codebooks with smaller sizes (e.g., sizes that are equal to or smaller than those of the (non-enhanced) type-3 HARQ-ACK codebooks in Rel-16) are supported, by providing the UE with information indicative of enabling the operation of multiple enhanced type-3 HARQ-ACK codebooks with smaller sizes and information indicative of which one of the multiple enhanced type-3 HARQ-ACK codebooks to be used. Specifically, an RRC configuration (e.g., a new RRC parameter) may be introduced and signaled to the UE to enable the operation of multiple enhanced type-3 HARQ-ACK codebooks with smaller sizes, and an indication in the triggering DCI format may indicate one of the multiple enhanced type-3 HARQ-ACK codebooks with smaller sizes, such that the UE may determine which one of the multiple enhanced type-3 HARQ-ACK codebooks should be used to report HARQ feedback information. By applying the schemes of the present disclosure, support of multiple enhanced type-3 HARQ-ACK codebooks with smaller sizes can be realized to allow dynamic selection of a proper codebook size for the HARQ feedback information. Applications with URLLC requirements or applications for unlicensed frequency bands can benefit from the enhancements achieved by the implementations of the present disclosure.

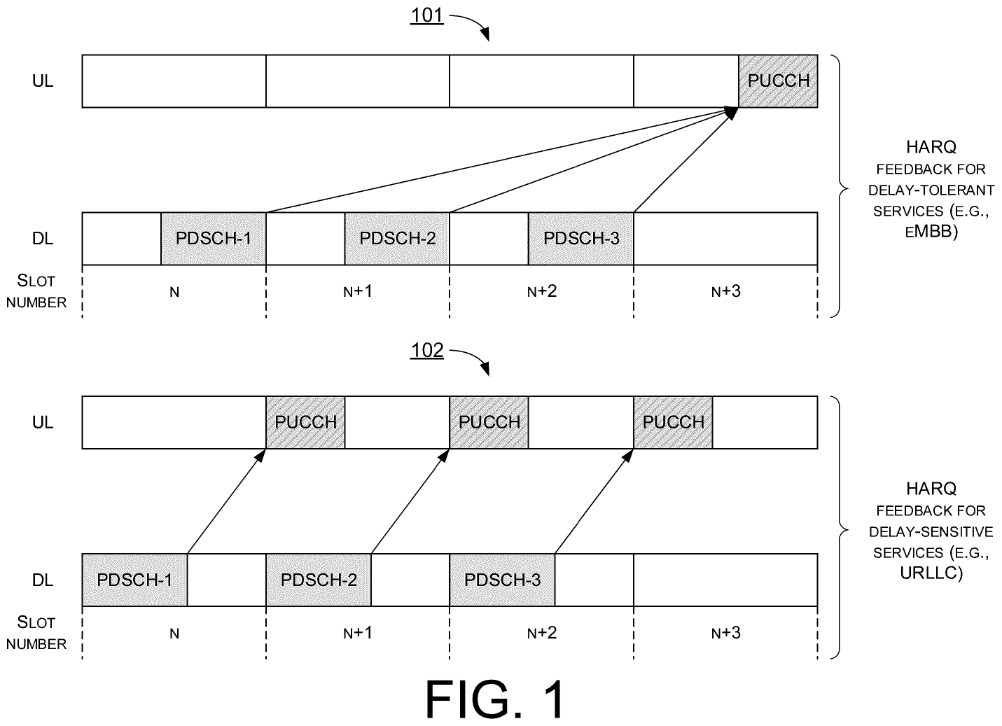

FIG. 1 illustrates example scenarios 101 and 102 under schemes in accordance with implementations of the present disclosure. Scenarios 101 and 102 involve a UE and a network node, which may be a part of a wireless communication network (e.g., an LTE network, a 5G network, an NR network, an IoT network or an NB-IoT network). The HARQ feedbacks for different codebooks (e.g., different services) could be operated differently based on the service requirements. For example, for delay-tolerant services such as enhanced mobile broadband (eMBB), the UE may construct a “large” HARQ-ACK codebook (e.g., a type-1, type-2, or (non-enhanced) type-3 HARQ-ACK codebook), where multiple downlink transport blocks are acknowledged within this large HARQ-ACK codebook. As shown in scenario 101, the HARQ-ACK information corresponding to the receptions of PDSCH-1, PDSCH-2 and PDSCH-3 can be multiplexed in one HARQ-ACK codebook and transmitted on one PUCCH. On the other hand, for delay-sensitive services such as URLLC, the network node may request the HARQ feedbacks as soon as possible. As shown in scenario 102, the HARQ-ACK information (e.g., feedback bits each indicating ACK or NACK) corresponding to the receptions of PDSCH-1, PDSCH-2 and PDSCH-3 is transmitted separately in a respective HARQ-ACK codebook on a closest PUCCH. In addition, there is also a case where the reporting of HARQ feedback information is based on what the UE has in its memory for the HARQ process, rather than based on the newly scheduled PDSCH.

In one novel aspect of the present disclosure, the HARQ-ACK codebook used for reporting the HARQ feedback information may be an enhanced type-3 HARQ-ACK codebook with a smaller size (e.g., a size equal to or smaller than that of a (non-enhanced) type-3 HARQ-ACK codebook in Rel-16), and the transmission of the HARQ feedback information may be a single-shot transmission triggered by a DCI format (or called a trigger DCI format) with an indication of one of multiple enhanced type-3 HARQ-ACK codebooks enabled simultaneously.

In some implementations, the UE may report its capability regarding the maximum number (e.g., X) of enhanced type-3 HARQ-ACK codebooks supported by the UE to the network node, and the network node may configure a number (e.g., Y) of multiple enhanced type-3 HARQ-ACK codebooks to the UE, wherein the configured number is less than or equal to the maximum number (i.e., Y≤X). For example, the UE may report a value among a list/set of pre-defined or specified values, such as {1, 2, 4, 8}, and the network node may configure up to 8 multiple enhanced type-3 HARQ-ACK codebooks based on the value reported by the UE.

In some implementations, the network node may send an RRC configuration including first information (e.g., the parameter “pdsch-HARQ-ACK-EnhType3DCI-Field” in the “PhysicalCellGroupConfig” Information Element (IE)) indicating that the operation of multiple enhanced type-3 HARQ-ACK codebooks is enabled, and second information (e.g., the parameter “pdsch-HARQ-ACK-EnhType3ToAddModList” or “pdsch-HARQ-ACK-EnhType3SecondaryToAddModList” in the “PhysicalCellGroupConfig” IE) configuring the number of the multiple enhanced type-3 HARQ-ACK codebooks.

In some implementations, the triggering DCI format may be a DCI format 1_1 or a DCI format 1_2, and the triggering DCI format can either schedule or not schedule a PDSCH.

In some implementations, the indication in the triggering DCI format may be a new DCI bit-field dedicated for indicating one of the multiple enhanced type-3 HARQ-ACK codebooks with smaller sizes. The size of the new DCI bit-field may be RRC configured, or may be determined, based on the number (e.g., Y) of the configured multiple enhanced type-3 HARQ-ACK codebooks, as [log₂ Y]. For example, in the case where Y is selected from the set of pre-defined values {1, 2, 4, 8}, the size of the new DCI bit-field may be 1, 2, or 3 bit(s) long. Alternatively, the size of the new DCI bit-field may be 0 bit if the RRC parameter (e.g., pdsch-HARQ-ACK-enhType3DCIfield) used to signal the UE to enable the operation of multiple enhanced type-3 HARQ-ACK codebooks is not configured.

In some implementations, if the triggering DCI format does not schedule a PDSCH, the indication may be the frequency domain resource allocation (FDRA) bit-field or another existing DCI bit-field, which is reused to indicate one of the multiple enhanced type-3 HARQ-ACK codebooks.

In some implementations, the sizes of the multiple enhanced type-3 HARQ-ACK codebooks may be determined based on at least one of the following: (1) a set of cells configured by the network node, and (2) a set of HARQ processes configured by the network node.

In some implementations, the sizes of the multiple enhanced type-3 HARQ-ACK codebooks may be explicitly configured to the UE by the network node.

### Illustrative Implementations

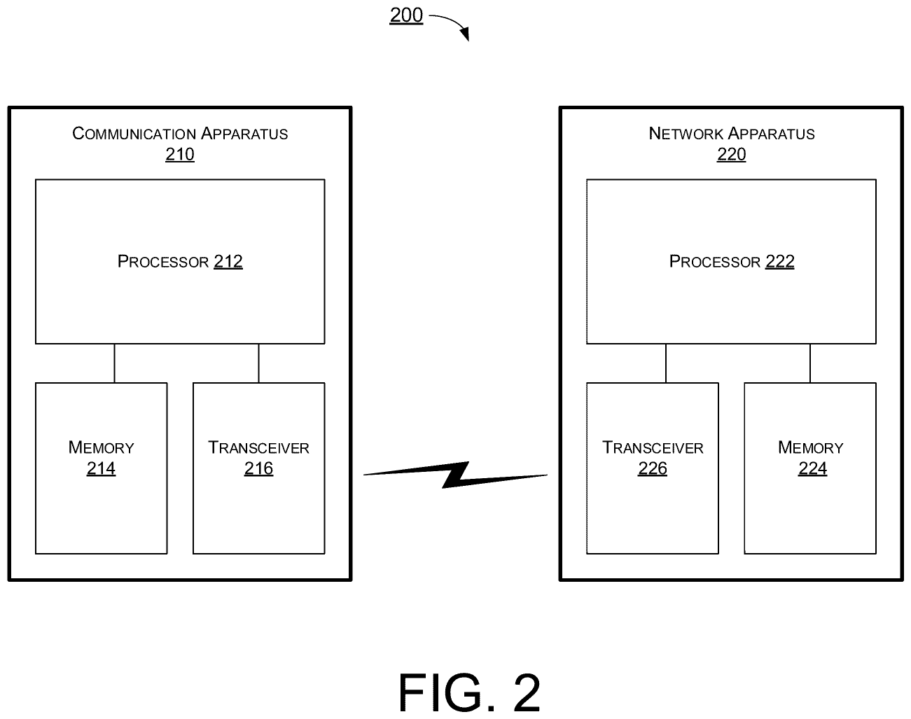

FIG. 2 illustrates an example communication system 200 having an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to supporting enhanced type-3 HARQ-ACK codebooks with respect to user equipment and network apparatus in mobile communications, including scenarios/schemes described above as well as process 300 described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus, which may be a network node such as a base station, a small cell, a router or a gateway. For instance, network apparatus 220 may be implemented in an eNodeB in an LTE, LTE-Advanced or LTE-Advanced Pro network or in a gNB in a 5G, NR, IoT, NB-IoT or IIOT network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including autonomous reliability enhancements in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE and network apparatus 220 is implemented in or as a network node of a communication network.

In some implementations, processor 212 may receive, via transceiver 216, an RRC configuration from the network apparatus 220, wherein the RRC configuration comprises first information indicating that an operation of multiple enhanced type-3 HARQ-ACK codebooks is enabled. Then, processor 212 may receive, via transceiver 216, a DCI format from the network apparatus 220, wherein the DCI format indicates one of the multiple enhanced type-3 HARQ-ACK codebooks. After that, processor 212 may receive, via transceiver 216, a PDSCH from the network apparatus 220, and use/construct the one of the multiple enhanced type-3 HARQ-ACK codebooks to report, via transceiver 216, HARQ-ACK feedback information corresponding to the PDSCH reception to the network apparatus 220.

### Illustrative Processes

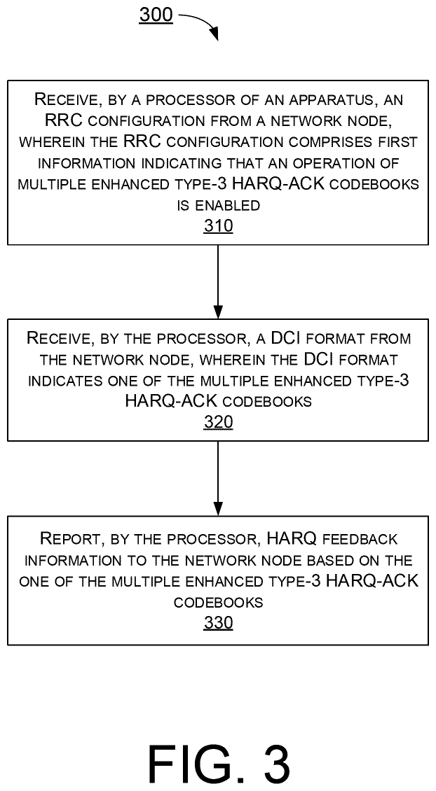

FIG. 3 illustrates an example process 300 in accordance with an implementation of the present disclosure. Process 300 may be an example implementation of above scenarios/schemes, whether partially or completely, with respect to supporting enhanced type-3 HARQ-ACK codebooks with the present disclosure. Process 300 may represent an aspect of implementation of features of communication apparatus 210. Process 300 may include one or more operations, actions, or functions as illustrated by one or more of blocks 310, 320, and 330. Although illustrated as discrete blocks, various blocks of process 300 may be divided into additional blocks, combined into fewer blocks, or eliminated, depending on the desired implementation. Moreover, the blocks of process 300 may be executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210. Process 300 may begin at block 310.

At 310, process 300 may involve processor 212 of communication apparatus 210 receiving, via transceiver 216, an RRC configuration from a network node (e.g., the network apparatus 220), wherein the RRC configuration comprises first information indicating that an operation of multiple enhanced type-3 HARQ-ACK codebooks is enabled. Process 300 may proceed from 310 to 320.

At 320, process 300 may involve processor 212 receiving, via transceiver 216, a DCI format from the network node, wherein the DCI format indicates one of the multiple enhanced type-3 HARQ-ACK codebooks. Process 300 may proceed from 320 to 330.

At 330, process 300 may involve processor 212 reporting, via transceiver 216, HARQ feedback information to the network node based on the one of the multiple enhanced type-3 HARQ-ACK codebooks.

In some implementations, process 300 may further involve processor 212 transmitting, via transceiver 216, a UE capability information to the network node, wherein the UE capability information indicates a maximum number of enhanced type-3 HARQ-ACK codebooks supported by the communication apparatus 210.

In some implementations, the RRC configuration may also comprise second information configuring a number of the multiple enhanced type-3 HARQ-ACK codebooks, and the number of the multiple enhanced type-3 HARQ-ACK codebooks is less than or equal to the maximum number of enhanced type-3 HARQ-ACK codebooks supported by the communication apparatus 210.

In some implementations, the DCI format may be a DCI format 1_1 or a DCI format 1_2.

In some implementations, the DCI format may comprise a bit-field indicating the one of the multiple enhanced type-3 HARQ-ACK codebooks, and a size of the bit-field is RRC configured or determined based on a number of the configured multiple enhanced type-3 HARQ-ACK codebooks. For example, the bit-field may be a new bit-field dedicated for indicating the one of the multiple enhanced type-3 HARQ-ACK codebooks. Alternatively, the bit-field may be an FDRA bit-field or another existing bit-field reused to indicate the one of the multiple enhanced type-3 HARQ-ACK codebooks, in a case where the DCI format does not schedule a PDSCH.

In some implementations, each of the multiple enhanced type-3 HARQ-ACK codebooks may have a respective size that is smaller than that of a Rel-16 type-3 HARQ-ACK codebook. The sizes of the multiple enhanced type-3 HARQ-ACK codebooks may be determined based on at least one of the following: (1) a set of cells configured by the network apparatus 220, and (2) a set of HARQ processes configured by the network apparatus 220. The sizes of the multiple enhanced type-3 HARQ-ACK codebooks may be explicitly configured to the communication apparatus 210 by the network apparatus 220.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a radio resource control (RRC) configuration from a network node, wherein the RRC configuration comprises first information indicating that an operation of multiple enhanced type-3 hybrid automatic repeat request-acknowledgement (HARQ-ACK) codebooks is enabled;
receiving, by the processor, a downlink control information (DCI) format from the network node, wherein the DCI format indicates one of the multiple enhanced type-3 HARQ-ACK codebooks; and
reporting, by the processor, HARQ feedback information to the network node based on the one of the multiple enhanced type-3 HARQ-ACK codebooks.

2. The method of claim 1, further comprising:
transmitting, by the processor, a UE capability information to the network node, wherein the UE capability information indicates a maximum number of enhanced type-3 HARQ-ACK codebooks supported by the UE.

3. The method of claim 2, wherein the RRC configuration comprises second information configuring a number of the multiple enhanced type-3 HARQ-ACK codebooks, and the number of the multiple enhanced type-3 HARQ-ACK codebooks is less than or equal to the maximum number of enhanced type-3 HARQ-ACK codebooks supported by the UE.

4. The method of claim 1, wherein the DCI format is a DCI format 1_1 or a DCI format 1_2.

5. The method of claim 3, wherein the DCI format comprises a bit-field indicating the one of the multiple enhanced type-3 HARQ-ACK codebooks, and a size of the bit-field is RRC configured or determined based on the number of the configured multiple enhanced type-3 HARQ-ACK codebooks.

6. The method of claim 5, wherein the bit-field is a new bit-field dedicated for indicating the one of the multiple enhanced type-3 HARQ-ACK codebooks.

7. The method of claim 5, wherein the bit-field is a frequency domain resource allocation (FDRA) bit-field or another existing bit-field reused to indicate the one of the multiple enhanced type-3 HARQ-ACK codebooks, in a case that the DCI format does not schedule a PDSCH.

8. The method of claim 1, wherein each of the multiple enhanced type-3 HARQ-ACK codebooks has a respective size that is equal to or smaller than that of a Rel-16 type-3 HARQ-ACK codebook.

9. The method of claim 1, wherein sizes of the multiple enhanced type-3 HARQ-ACK codebooks are determined based on at least one of the following:
a set of cells configured by the network node; and
a set of HARQ processes configured by the network node.

10. The method of claim 1, wherein sizes of the multiple enhanced type-3 HARQ-ACK codebooks are explicitly configured to the UE by the network node.

11. An apparatus, comprising:
a transceiver which, during operation, wirelessly communicates with at least one network node of a wireless network; and
a processor communicatively coupled to the transceiver such that, during operation, the processor performs operations comprising:
receiving, via the transceiver, a radio resource control (RRC) configuration from a network node, wherein the RRC configuration comprises first information indicating that an operation of multiple enhanced type-3 hybrid automatic repeat request-acknowledgement (HARQ-ACK) codebooks is enabled;
receiving, via the transceiver, a downlink control information (DCI) format from the network node, wherein the DCI format indicates one of the multiple enhanced type-3 HARQ-ACK codebooks; and
reporting, via the transceiver, HARQ feedback information to the network node based on the one of the multiple enhanced type-3 HARQ-ACK codebooks.

12. The apparatus of claim 11, wherein, during operation, the processor further performs operations comprising:
transmitting, via the transceiver, a UE capability information to the network node, wherein the UE capability information indicates a maximum number of enhanced type-3 HARQ-ACK codebooks supported by the UE.

13. The apparatus of claim 12, wherein the RRC configuration comprises second information configuring a number of the multiple enhanced type-3 HARQ-ACK codebooks, and the number of the multiple enhanced type-3 HARQ-ACK codebooks is less than or equal to the maximum number of enhanced type-3 HARQ-ACK codebooks supported by the UE.

14. The apparatus of claim 11, wherein the DCI format is a DCI format 1_1 or a DCI format 1_2.

15. The apparatus of claim 13, wherein the DCI format comprises a bit-field indicating the one of the multiple enhanced type-3 HARQ-ACK codebooks, and a size of the bit-field is RRC configured or determined based on the number of the configured multiple enhanced type-3 HARQ-ACK codebooks.

16. The apparatus of claim 15, wherein the bit-field is a new bit-field dedicated for indicating the one of the multiple enhanced type-3 HARQ-ACK codebooks.

17. The apparatus of claim 15, wherein the bit-field is a frequency domain resource allocation (FDRA) bit-field or another existing bit-field reused to indicate the one of the multiple enhanced type-3 HARQ-ACK codebooks, in a case that the DCI format does not schedule a PDSCH.

18. The apparatus of claim 11, wherein each of the multiple enhanced type-3 HARQ-ACK codebooks has a respective size that is equal to or smaller than that of a Rel-16 type-3 HARQ-ACK codebook.

19. The apparatus of claim 11, wherein sizes of the multiple enhanced type-3 HARQ-ACK codebooks are determined based on at least one of the following:
a set of cells configured by the network node; and
a set of HARQ processes configured by the network node.

20. The apparatus of claim 11, wherein sizes of the multiple enhanced type-3 HARQ-ACK codebooks are explicitly configured to the UE by the network node.
